(19) United States
(12) Patent Application Publication
(10) Pub. No.: US 2026/0313362 A1
(43) Pub. Date: Oct. 8, 2026

(54) COMMUNICATION METHOD AND COMMUNICATION APPARATUS

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/472,333

(22) PCT Filed: Apr. 7, 2023
(86) PCT No.: PCT/CN2023/087074

§ 371 Date: Oct. 3, 2025

(51) Int. Cl. H04W 8/24

(52) U.S. Cl. CPC H04W 8/24

(57) ABSTRACT

An approach for advertising artificial-intelligence (AI) capabilities of a wireless terminal to a network device. The terminal determines an AI functionality supported by the terminal based on values across multiple dimensional information, which may include operating frequency band, application scenario, inputs and/or outputs of an AI model, and configuration information. The terminal transmits first information that indicates the AI functionality, for example by including a functionality identification corresponding to the determined functionality and/or the values under the different dimensional information. The functionality identification may be derived by the terminal in a custom-defined manner or assigned by the network device from the transmitted values. In some embodiments, the terminal and/or network device determine the supported AI functionality using second or third information that identifies dimensional categories and/or values for a plurality of AI functionalities.

### CROSS-REFERENCE

The present application is a U.S. National Stage of International Application No. PCT/CN2023/087074, filed on Apr. 7, 2023, the entire content of which is incorporated herein by reference for all purposes.

### TECHNICAL FIELD

The present disclosure relates to the field of communication technologies, and more particularly, to a communication method, an apparatus, and a non-transitory storage medium.

### BACKGROUND

In recent years, the Artificial Intelligence (AI) technology has made continuous breakthroughs in multiple fields. In the related art, the AI technology is introduced into a wireless air interface to assist in improving the transmission technology of the wireless air interface. At present, it has been suggested to apply the AI technology in the wireless air interface for communication processing, including training of AI models and inference application of the models.

### SUMMARY

In order to overcome problems existing in the related art, the present disclosure provides a communication method, an apparatus, and a non-transitory storage medium.

According to a first aspect of the embodiments of the present disclosure, a communication method is provided, the method being performed by a terminal, the method including: sending first information, where the first information is configured to indicate an AI functionality supported by the terminal, and the AI functionality is determined based on different dimensional information.

According to a second aspect of the embodiments of the present disclosure, a communication method is provided, the method being performed by a network device, the method including: receiving first information, where the first information is configured to indicate an AI functionality supported by a terminal, and the AI functionality is determined based on different dimensional information.

According to a third aspect of the embodiments of the present disclosure, a communication apparatus is provided, including: a processor; and a memory for storing processor-executable instructions; where the processor is configured to: execute the communication method according to the above first aspect and the embodiments in the first aspect.

According to a fourth aspect of the embodiments of the present disclosure, a communication apparatus is provided, including: a processor; and a memory for storing processor-executable instructions; where the processor is configured to: execute the communication method according to the above second aspect and the embodiments in the second aspect.

It should be understood that the foregoing general description and the following detailed description are merely exemplary and explanatory, and are not intended to limit the present disclosure.

### BRIEF DESCRIPTION OF THE DRAWINGS

The drawings herein are incorporated into the specification and constitute a part of the specification, which illustrate embodiments consistent with the present disclosure and, together with the specification, serve to explain the principles of the present disclosure.

FIG. 1 is a schematic diagram of a wireless communication system according to an embodiment.

FIG. 2 is a flowchart of a communication method according to an embodiment.

FIG. 3 is a flowchart of a communication method according to an embodiment.

FIG. 4 is a block diagram of a communication apparatus according to an embodiment.

FIG. 5 is a block diagram of a communication apparatus according to an embodiment.

FIG. 6 is a block diagram for a communication apparatus according to an embodiment.

FIG. 7 is a block diagram for a communication apparatus according to an embodiment.

### DETAILED DESCRIPTION

Embodiments will be described in detail herein, examples of which are illustrated in the drawings. In the following description with reference to the drawings, unless otherwise indicated, the same numerals in different drawings denote the same or similar elements. The embodiments described in the following do not represent all embodiments consistent with the present disclosure.

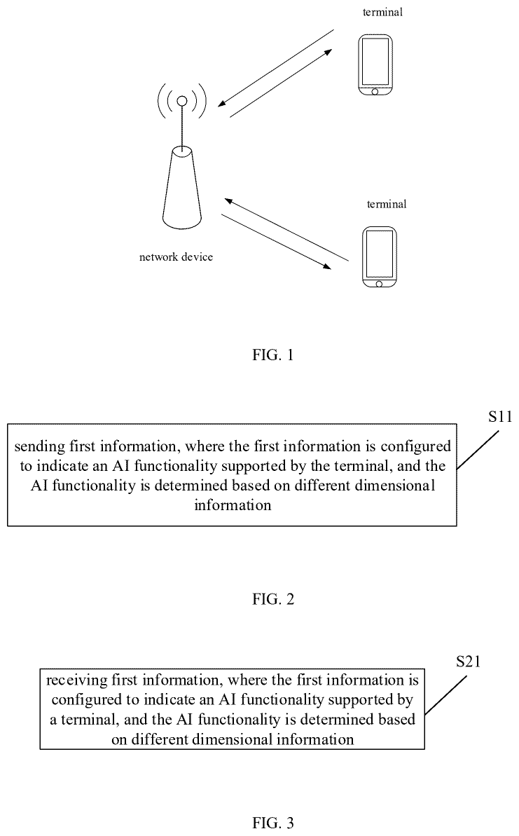

The communication method provided in embodiments of the present disclosure may be applied to a wireless communication system shown in FIG. 1. Referring to FIG. 1, the wireless communication system includes a network device and a terminal. The terminal is connected to the network device through wireless resources and performs data transmission.

It may be understood that the wireless communication system shown in FIG. 1 is merely for illustrative description. The wireless communication system may further include another network device, such as a core network device, a wireless relay device, and a wireless backhaul device, and the like, which is not shown in FIG. 1. The embodiments of the present disclosure are not limited to the number of network devices and the number of terminals included in the wireless communication system.

It may be further understood that the wireless communication system in the embodiments of the present disclosure is a network providing wireless communication functions. The wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency-division multiple access (SC-FDMA), carrier sense multiple access with collision avoidance (CSMA/CA). According to factors such as capacity, rate, and delay of different networks, the network may be divided into a 2G (generation) network, a 3G network, a 4G network, or a future evolution network, such as a 5G network, which may also be referred to as a New Radio (NR) network. For ease of description, the present disclosure may sometimes refer to a wireless communication network simply as a network.

Furthermore, the network device involved in the present disclosure may also be referred to as a wireless access network device. The wireless access network device may be: a base station, an evolved node B (eNB, base station), a home base station, an access point (AP) in a wireless fidelity (WIFI) system, a wireless relay node, a wireless backhaul node, a transmission point (TP), or a transmission and reception point (TRP), etc., and may also be a gNB in an NR system, or further, may be a component or part of device constituting a base station. It should be understood that the embodiments of the present disclosure are not limited to the specific technologies and specific device forms adopted by the network device. In the present disclosure, the network device may provide communication coverage for a specific geographical area, and may communicate with a terminal located within the coverage area (a cell). In addition, when it is a Vehicle-to-Everything (V2X) communication system, the network device may also be an on-board device.

Furthermore, the terminal involved in the present disclosure may also be referred to as a terminal device, user equipment (UE), mobile station (MS), mobile terminal (MT), etc., which is a device providing voice and/or data connectivity to a user. For example, the terminal may be a handheld device with a wireless connection function, an on-board device, etc. At present, examples of some terminals include: mobile phones, customer premises equipment, pocket personal computers (PPC), handheld computers, personal digital assistants (PDA), notebook computers, tablet computers, wearable devices, or on-board devices, etc. In addition, when it is a Vehicle-to-Everything (V2X) communication system, the terminal device may also be an on-board device. It should be understood that the embodiments of the present disclosure are not limited to the specific technologies and specific device forms adopted by the terminal.

In recent years, Artificial Intelligence (AI) technology has made continuous breakthroughs in multiple fields. The continuous development in the fields of intelligent voice and computer vision not only brings a variety of colorful applications to intelligent terminals, but also has wide applications in many fields such as education, transportation, home, medical treatment, retail, and security, bringing convenience to people's lives while also promoting industrial upgrading in various industries. AI technology is also accelerating cross-penetration with other disciplinary fields, and its development not only integrates knowledge of different disciplines, but also provides new directions and methods for the development of different disciplines.

In the related art, a research project on AI technology in the wireless air interface is established in the Radio Access Network (RAN), so as to introduce artificial intelligence technology into the radio air interface to assist in improving transmission technology of the radio air interface. In addition, the application of AI technology in the radio air interface for communication processing has been supported, including the training of AI models and inference applications of the models. In a deployment scheme based on an AI model, the AI model may be deployed on a terminal side, but a network device needs to participate in the management of the AI model, and therefore, the network device and the terminal need to align information related to the AI model. That is, the terminal needs to report an AI functionality supported by the terminal.

In the related art, one AI feature or machine learning (ML) feature may include one or a plurality of functionalities, where each functionality may be directed to a specific application environment or application scenario.

In the embodiments of the present disclosure, an AI/ML feature may be an AI/ML use case. For example, the AI/ML feature may be CSI compression, time-domain CSI prediction, or AI-based spatial-domain beam prediction.

In this case, one or a plurality of AI models may be included under one functionality.

However, it is currently unclear how the functionality is determined, and it is also unclear how the functionality is reported.

FIG. 2 is a flowchart of a communication method according to an embodiment. As shown in FIG. 2, the communication method is applied in a terminal and includes the following step S11.

In step S11, first information is sent, where the first information is configured to indicate an AI functionality supported by the terminal, and the AI functionality is determined based on different dimensional information.

In some embodiments, the AI functionality is configured to indicate relevant information of the AI model. For example, an application scenario of the AI model.

In some embodiments, the AI functionality may be a CSI compression functionality, an AI-based beam prediction functionality, an AI-based positioning functionality, and the like.

In some embodiments, the dimensional information may be determined based on a predefined configuration. For example, the dimensional information may be determined based on a protocol predefined configuration or based on a network device predefined configuration.

In some embodiments, the dimensional information may be determined based on a custom definition of the terminal, for example, the terminal determines the dimensional information supported by itself.

In the embodiments of the present disclosure, the terminal sends the first information, and indicates the AI functionality supported by the terminal through the first information, such that the network device and the terminal may reach an agreement on the AI functionality supported by the terminal. Furthermore, different AI functionalities are determined based on different dimensional information, thereby clarifying the determination basis of the AI functionality and improving communication efficiency.

In a communication method provided in the embodiments of the present disclosure, the dimensional information includes at least one of the following:
an operating frequency band;
an application scenario;
an input and/or an output of an AI model; or
configuration information.

In some embodiments, the dimensional information includes an operating frequency band.

In some embodiments, different AI functionalities are determined based on the operating frequency bands to which the AI model is applied. For example, different operating frequency bands correspond to different AI functionalities.

In some embodiments, the dimensional information includes an application scenario.

In some embodiments, different AI functionalities are determined based on the application scenarios to which the AI model is applied. For example, the application scenario may be a cell type, and different cell types correspond to different AI functionalities.

In some embodiments, the dimensional information includes an input and/or an output of an AI model.

In some embodiments, different AI functionalities are determined based on the inputs and/or the outputs of the AI model. For example, by defining the input and/or output of the AI model, AI models with different inputs and/or outputs correspond to different AI functionalities.

In some embodiments, the dimensional information includes configuration information.

In some embodiments, different AI functionalities are determined based on different configuration information.

In some embodiments, the dimensional information includes one or more of the operating frequency band, the application scenario, the input and/or output of an AI model, and the configuration information, and the AI functionality is determined based on one or more dimensional information. The embodiments of the present disclosure do not limit the combination of dimensional information.

In the embodiments of the present disclosure, by defining the dimensional information for determining AI functionalities, the terminal may clearly understand how to determine and classify the AI functionality, thereby improving the communication efficiency.

In a communication method provided in the embodiments of the present disclosure, each dimensional information includes at least one value, and the AI functionality is determined based on the values under the different dimensional information.

In some embodiments, the dimensional information includes the operating frequency band.

In some embodiments, the values corresponding to the operating frequency band may include operating frequency band 1 and operating frequency band 2.

For example, the AI functionality 1 is determined based on the operating frequency band 1, and the AI functionality 2 is determined based on the operating frequency band 2.

In some embodiments, the dimensional information includes the application scenario.

In some embodiments, the values corresponding to the application scenario may include a macro cell and a micro cell.

For example, the AI functionality 1 is determined for the macro cell, and the AI functionality 2 is determined for the micro cell.

In some embodiments, the dimensional information includes the input or the output of the AI model.

In some embodiments, the input or the output of the AI model may include the inputs or the outputs with different bit values.

For example, an AI model with an X-bit output corresponds to the AI functionality 1, and an AI model with a Y-bit output corresponds to the AI functionality 2.

In some embodiments, the dimensional information includes the configuration information.

For example, the configuration 1 corresponds to the AI functionality 1, and the configuration 2 corresponds to the AI functionality 2.

In the embodiments of the present disclosure, the dimensional information of the AI functionality is determined based on values under the different dimensional information, such that the terminal clearly knows how to determine and classify the AI functionality, thereby improving the communication efficiency.

In the communication method provided in the embodiments of the present disclosure, different AI functionalities correspond to different functionality identifications.

In some embodiments, the functionality identification may be an ID or a name, as long as different AI functionalities may be distinguished, and the embodiments of the present disclosure are not limited thereto.

In some embodiments, the functionality identifications of the different AI functionalities may be determined by the terminal, or may be determined by the network device.

The following describes how the terminal reports the AI functionality supported by the terminal.

In a first manner, the terminal determines the AI functionality supported by the terminal based on second information.

In some embodiments, the second information is predefined by a network device, or predefined by a protocol, or predefined by another entity.

In some embodiments, the second information includes dimensional information respectively corresponding to a plurality of AI functionalities, and values respectively corresponding to the plurality of AI functionalities under the different dimensional information.

For example, the second information includes an operating frequency band and configuration information, where values of the operating frequency band are FR1 or FR2, and values of the configuration information are configuration 1 or configuration 2. The terminal may then determine four AI functionalities, namely, an AI functionality under FR1 and configuration 1, an AI functionality under FR1 and configuration 2, an AI functionality under FR2 and configuration 1, and an AI functionality under FR2 and configuration 2.

In some embodiments, the terminal determines functionality identifications of the plurality of AI functionalities based on the dimensional information respectively corresponding to the plurality of AI functionalities and the values respectively corresponding to the plurality of AI functionalities under the different dimensional information, where the dimensional information and the values are included in the second information.

In some embodiments, the first information reported by the terminal is a functionality identification of the AI functionality supported by the terminal.

In the embodiments of the present disclosure, the configuration information corresponding to the AI functionality and its value are predefined by the second information, and the terminal reports the functionality identification of the AI functionality supported by the terminal based on the predefined second information, such that the network device may determine an application condition of the AI functionality of the terminal based on the functionality identification.

In a second manner, the terminal custom-defines the AI functionality supported by the terminal. In some embodiments, the terminal determines the AI functionality based on dimensional information.

In some embodiments, the dimensional information is predetermined by a network device or a protocol.

In some embodiments, the terminal determines the value corresponding to the AI functionality under the dimensional information.

In some embodiments, the terminal reports different values corresponding to the AI functionality under the different dimensional information. That is, the first information includes values of the AI functionality supported by the terminal under the different dimensional information.

For example, the first information may include two AI functionalities and values of the two AI functionalities under different dimensional information. For example, the value of the first AI functionality under different dimensional information are: operating frequency band: FR1; application scenario: macro cell; the value of the second AI functionality under different dimensional information are: operating frequency band: FR2; application scenario: micro cell.

In some embodiments, the terminal is capable of customizing the assignment of functionality identifications to different AI functionalities.

In some embodiments, the first information includes a functionality identification of the AI functionality supported by the terminal.

In some embodiments, the functionality identification of the AI functionality supported by the terminal is determined by the network device based on the values of the AI functionality supported by the terminal under different dimensional information.

For example, the terminal sends first information to the network device, the network device determines the values of the AI functionalities supported by the terminal under different dimensional information based on the first information, and names the different AI functionalities.

In some embodiments, the network device is capable of sending fourth information to the terminal, such that the terminal determines the functionality identification of the AI functionality based on the fourth information.

In the embodiments of the present disclosure, the terminal determines the AI functionality and the first information that needs to be reported to the network device based on the dimensional information in a custom-defined manner, such that the network device is capable of determining the AI functionality supported by the terminal and the specific application condition under different dimensional information based on the first information.

In a third manner, the terminal determines the AI functionality supported by the terminal based on third information, and reports the dimensional information supported by the terminal under different AI functionalities in a custom-defined manner.

In some embodiments, the third information is configured to indicate at least one dimensional information.

In some embodiments, the terminal determines the AI functionality supported by the terminal based on the third information.

In some embodiments, the terminal determines a functionality identification for the AI functionality supported by the terminal.

In some embodiments, the first information includes a functionality identification of the AI functionality supported by the terminal.

For example, the dimensional information indicated by the third information is an operating frequency band, and the terminal determines the AI functionality supported by the terminal as functionality #1 and functionality #2 based on the operating frequency band, and reports functionality #1 and functionality #2.

In some embodiments, the first information further includes values of the AI functionality supported by the terminal under another dimensional information.

In some embodiments, the another dimensional information does not include at least one dimensional information indicated by the third information.

For example, the terminal determines the AI functionality supported by the terminal as functionality #1 and functionality #2 based on the operating frequency band indicated by the third information, and determines that the application scenario supported by functionality #1 is a macro cell and the application scenario supported by functionality #2 is a micro cell, where the first information may further include that the application scenario supported by functionality #1 is a macro cell and the application scenario supported by functionality #2 is a micro cell.

In one embodiment, the functionality identification of the AI functionality supported by the terminal and the value of the AI functionality supported by the terminal under another dimensional information may be carried in the same first information, or may be carried in different first information.

In the embodiments of the present disclosure, the terminal determines the AI functionality supported by the terminal based on the third information and customizes the first information reported by the terminal, such that the network device is capable of determining the AI functionality supported by the terminal and the specific application condition under different dimensional information based on the first information.

Based on the same concept, the embodiments of the present disclosure further provide a communication method executed by a network device.

FIG. 3 is a flowchart of a communication method according to an embodiment. As shown in FIG. 3, the communication method is applied in a network device and includes the following step S21.

In step S11, first information is received, where the first information is configured to indicate an AI functionality supported by a terminal, and the AI functionality is determined based on different dimensional information.

In some embodiments, the AI functionality is configured to indicate relevant information of the AI model. For example, an application scenario of the AI model.

In some embodiments, the AI functionality may be a CSI compression functionality, an AI-based beam prediction functionality, an AI-based positioning functionality, and the like.

In some embodiments, the dimensional information is determined based on a predefined configuration. For example, the dimensional information may be determined based on a protocol predefined configuration or based on a network device predefined configuration.

In the embodiments of the present disclosure, the network device receives the first information, and determines the AI functionality supported by the terminal through the first information, such that the network device and the terminal may reach an agreement on the AI functionality supported by the terminal.

In a communication method provided in the embodiments of the present disclosure, the dimensional information includes at least one of the following:
an operating frequency band;
an application scenario;
an input and/or an output of an AI model; or
configuration information.

In some embodiments, the dimensional information includes an operating frequency band.

In some embodiments, different AI functionalities are determined based on the operating frequency bands to which the AI model is applied. For example, different operating frequency bands correspond to different AI functionalities.

In some embodiments, the dimensional information includes an application scenario.

In some embodiments, different AI functionalities are determined based on the application scenarios to which the AI model is applied. For example, the application scenario may be a cell type, and different cell types correspond to different AI functionalities.

In some embodiments, the dimensional information includes an input and/or an output of an AI model.

In some embodiments, different AI functionalities are determined based on the inputs and/or the outputs of the AI model. For example, by defining the input and/or output of the AI model, AI models with different inputs and/or outputs correspond to different AI functionalities.

In some embodiments, the dimensional information includes configuration information.

In some embodiments, different AI functionalities are determined based on different configuration information.

In some embodiments, the dimensional information includes one or more of the operating frequency band, the application scenario, the input and/or output of an AI model, and the configuration information, and the AI functionality is determined based on one or more dimensional information. The embodiments of the present disclosure do not limit the combination of dimensional information.

In the embodiments of the present disclosure, by defining the dimensional information for determining AI functionalities, the terminal may clearly understand how to determine and classify the AI functionality, thereby improving the communication efficiency.

In a communication method provided in the embodiments of the present disclosure, each dimensional information includes at least one value, and the AI functionality is determined based on the values under the different dimensional information.

In some embodiments, the dimensional information includes the operating frequency band.

In some embodiments, the values corresponding to the operating frequency band may include operating frequency band 1 and operating frequency band 2.

For example, the AI functionality 1 is determined based on the operating frequency band 1, and the AI functionality 2 is determined based on the operating frequency band 2.

In some embodiments, the dimensional information includes the application scenario.

In some embodiments, the values corresponding to the application scenario may include a macro cell and a micro cell.

For example, the AI functionality 1 is determined for the macro cell, and the AI functionality 2 is determined for the micro cell.

In some embodiments, the dimensional information includes the input or the output of the AI model.

In some embodiments, the input or the output of the AI model may include the inputs or the outputs with different bit values.

For example, an AI model with an X-bit output corresponds to the AI functionality 1, and an AI model with a Y-bit output corresponds to the AI functionality 2.

In some embodiments, the dimensional information includes the configuration information.

For example, the configuration 1 corresponds to the AI functionality 1, and the configuration 2 corresponds to the AI functionality 2.

In the embodiments of the present disclosure, the dimensional information of the AI functionality is determined based on values under the different dimensional information, such that the terminal clearly knows how to determine and classify the AI functionality, thereby improving the communication efficiency.

In the communication method provided in the embodiments of the present disclosure, different AI functionalities correspond to different functionality identifications.

In some embodiments, the functionality identification may be an ID or a name, as long as different AI functionalities may be distinguished, and the embodiments of the present disclosure are not limited thereto.

In some embodiments, the functionality identifications of the different AI functionalities may be determined by the terminal, or may be determined by the network device.

The following describes how the terminal reports the AI functionality supported by the terminal. In a first manner, the terminal determines the AI functionality supported by the terminal based on second information.

In some embodiments, the second information is predefined by a network device, or predefined by a protocol, or predefined by another entity.

In some embodiments, the second information includes dimensional information respectively corresponding to a plurality of AI functionalities, and values respectively corresponding to the plurality of AI functionalities under the different dimensional information.

For example, the second information includes an operating frequency band and configuration information, where values of the operating frequency band are FR1 or FR2, and values of the configuration information are configuration 1 or configuration 2. The terminal may then determine four AI functionalities, namely, an AI functionality under FR1 and configuration 1, an AI functionality under FR1 and configuration 2, an AI functionality under FR2 and configuration 1, and an AI functionality under FR2 and configuration 2.

In some embodiments, the terminal determines functionality identifications of the plurality of AI functionalities based on the dimensional information respectively corresponding to the plurality of AI functionalities and the values respectively corresponding to the plurality of AI functionalities under the different dimensional information, where the dimensional information and the values are included in the second information.

In some embodiments, the first information reported by the terminal is a functionality identification of the AI functionality supported by the terminal.

In the embodiments of the present disclosure, the configuration information corresponding to the AI functionality and its value are predefined by the second information, and the terminal reports the functionality identification of the AI functionality supported by the terminal based on the predefined second information, such that the network device may determine an application condition of the AI functionality of the terminal based on the functionality identification.

In a second manner, the terminal custom-defines the AI functionality supported by the terminal.

In some embodiments, the terminal determines the AI functionality based on dimensional information.

In some embodiments, the dimensional information is predetermined by a network device or a protocol.

In some embodiments, the terminal determines the value corresponding to the AI functionality under the dimensional information.

In some embodiments, the terminal reports different values corresponding to the AI functionality under the different dimensional information. That is, the first information includes values of the AI functionality supported by the terminal under the different dimensional information.

For example, the first information may include two AI functionalities and values of the two AI functionalities under different dimensional information. For example, the value of the first AI functionality under different dimensional information are: operating frequency band: FR1; application scenario: macro cell; the value of the second AI functionality under different dimensional information are: operating frequency band: FR2; application scenario: micro cell.

In some embodiments, the terminal is capable of determining, in a custom-defined manner, the functionality identifications to different AI functionalities.

In some embodiments, the first information includes a functionality identification of the AI functionality supported by the terminal.

In some embodiments, the functionality identification of the AI functionality supported by the terminal is determined by the network device based on the values of the AI functionality supported by the terminal under different dimensional information.

For example, the terminal sends first information to the network device, the network device determines the values of the AI functionalities supported by the terminal under different dimensional information based on the first information, and names the different AI functionalities.

In some embodiments, the network device is capable of sending fourth information to the terminal, such that the terminal determines the functionality identification of the AI functionality based on the fourth information.

In the embodiments of the present disclosure, the terminal determines the AI functionality and the first information that needs to be reported to the network device based on the dimensional information in a custom-defined manner, such that the network device is capable of determining the AI functionality supported by the terminal and the specific application condition under different dimensional information based on the first information.

In a third manner, the terminal determines the AI functionality supported by the terminal based on third information, and reports the dimensional information supported by the terminal under different AI functionalities in a custom-defined manner.

In some embodiments, the third information is configured to indicate at least one dimensional information.

In some embodiments, the terminal determines the AI functionality supported by the terminal based on the third information.

In some embodiments, the terminal determines a functionality identification for the AI functionality supported by the terminal.

In some embodiments, the first information includes a functionality identification of the AI functionality supported by the terminal.

For example, the dimensional information indicated by the third information is an operating frequency band, and the terminal determines the AI functionality supported by the terminal as functionality #1 and functionality #2 based on the operating frequency band, and reports functionality #1 and functionality #2.

In some embodiments, the first information further includes values of the AI functionality supported by the terminal under another dimensional information.

In some embodiments, the another dimensional information does not include at least one dimensional information indicated by the third information.

For example, the terminal determines the AI functionality supported by the terminal as functionality #1 and functionality #2 based on the operating frequency band indicated by the third information, and determines that the application scenario supported by functionality #1 is a macro cell and the application scenario supported by functionality #2 is a micro cell, where the first information may further include that the application scenario supported by functionality #1 is a macro cell and the application scenario supported by functionality #2 is a micro cell.

In one embodiment, the functionality identification of the AI functionality supported by the terminal and the value of the AI functionality supported by the terminal under another dimensional information may be carried in the same first information, or may be carried in different first information.

In the embodiments of the present disclosure, the terminal determines the AI functionality supported by the terminal based on the third information and customizes the first information reported by the terminal, such that the network device is capable of determining the AI functionality supported by the terminal and the specific application condition under different dimensional information based on the first information.

It should be noted that those skilled in the art may understand that various embodiments/examples involved in the embodiments of the present disclosure may be used in combination with the foregoing embodiments, or may be used independently. Whether used independently or in conjunction with the foregoing embodiments, the implementation principles are similar. In the present disclosure, some embodiments are described in a manner of being used together. Of course, those skilled in the art may understand that such illustrative description is not intended to limit the embodiments of the present disclosure.

Based on the same concept, the embodiments of the present disclosure further provide a communication apparatus.

It may be understood that, in order to implement the above-mentioned functions, the communication apparatus provided by the embodiments of the present disclosure includes corresponding hardware structures and/or software modules for executing each function.

Combining with the units and algorithm steps of each example disclosed in the embodiments of the present disclosure, the embodiments of the present disclosure may be implemented in hardware or a combination of hardware and computer software. Whether a function is performed by hardware or computer software driving hardware depends on the specific application and design constraints of the technical solution. Those skilled in the art may use different methods for each specific application to implement the described functions, but such implementation should not be considered beyond the scope of the technical solutions of the embodiments of the present disclosure.

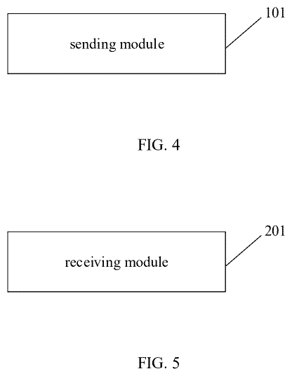

FIG. 4 is a block diagram of a communication apparatus according to an embodiment. Referring to FIG. 4, the communication includes a sending module 101.

The sending module 101 is configured to send first information, where the first information is configured to indicate an AI functionality supported by a terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, where the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, and the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, and the functionality identification of the AI functionality supported by the terminal is determined by the terminal in a custom-defined manner.

In some embodiments, the functionality identification of the AI functionality supported by the terminal is determined by a network device based on the values of the AI functionality supported by the terminal under the different dimensional information.

In some embodiments, the AI functionality supported by the terminal is determined based on third information, and the third information is configured to indicate at least one dimensional information.

In some embodiments, the first information includes a functionality identification of the AI functionality supported by the terminal, and the functionality identification of the AI functionality supported by the terminal is determined by the terminal in a custom-defined manner.

In some embodiments, the first information further includes a value of the AI functionality supported by the terminal under another dimensional information.

FIG. 5 is a block diagram of a communication apparatus according to an embodiment. Referring to FIG. 5, the apparatus includes a receiving module 201.

The receiving module 201 is configured to receive first information, where the first information is configured to indicate the AI functionality supported by a terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, and the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, and the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, and the functionality identification of the AI functionality supported by the terminal is determined by the terminal in a custom-defined manner.

In some embodiments, the functionality identification of the AI functionality supported by the terminal is determined by the network device based on the values of the AI functionality supported by the terminal under the different dimensional information.

In some embodiments, the AI functionality supported by the terminal is determined based on third information, and the third information is configured to indicate at least one dimensional information.

In some embodiments, the first information includes a functionality identification of the AI functionality supported by the terminal, and the functionality identification of the AI functionality supported by the terminal is determined by the terminal in a custom-defined manner.

In some embodiments, the first information further includes a value of the AI functionality supported by the terminal under another dimensional information.

Regarding the apparatus in the above embodiment, the specific manner in which each module performs operations has been described in detail in the embodiment of the method, and will not be described in detail here.

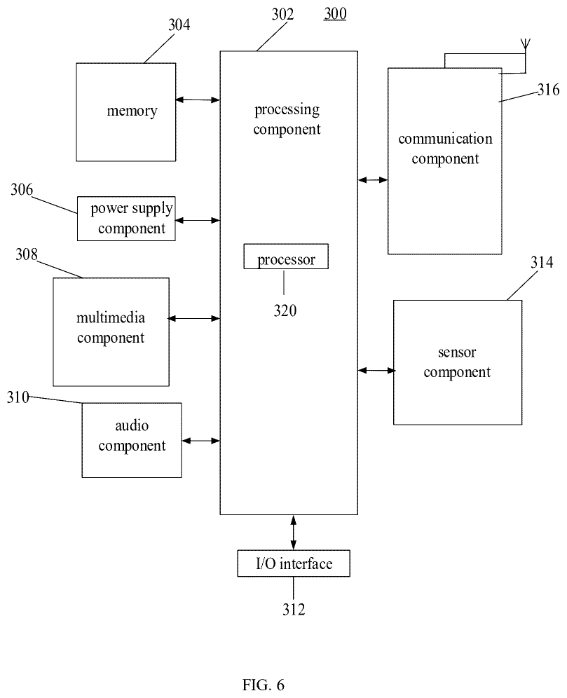

FIG. 6 is a block diagram illustrating a apparatus 300 according to an embodiment of the disclosure. For example, the apparatus 300 may be a mobile phone, a computer, a digital broadcasting UE, a messaging device, a game console, a tablet device, a medical equipment, a fitness equipment, a personal digital assistant, and so on.

Referring to FIG. 6, the apparatus 300 may include one or more components of the followings: a processing component 302, a memory 304, a power supply component 306, a multimedia component 308, an audio component 310, an input/output (I/O) interface 312, a sensor component 314, and a communication component 316.

The processing component 302 generally controls the whole operation of the apparatus 300, such as the operations related to display, phone call, data communication, camera operation and recording operation. The processing component 302 may include one or more processors 320 to perform instructions, to complete all or part of blocks of the above method. In addition, the processing component 302 may include one or more modules for the convenience of interaction between the processing component 302 and other components. For example, the processing component 302 may include a multimedia module for the convenience of interaction between the multimedia component 308 and the processing component 302.

The memory 304 is configured to store all types of data to support the operation of the apparatus 300. Examples of the data include the instructions of any applications or methods operated on the apparatus 300, contact data, phone book data, messages, pictures, videos, etc. The memory 304 may be implemented by any type of temporary or non-temporary storage devices or their combination, such as a static random access memory (SRAM), an electrically erasable programmable read-only memory (EEPROM), an electrically programmable read-only memory (EPROM), a programmable read-only memory (PROM), a read-only memory (ROM), a magnetic memory, a flash memory, a magnetic disk or an optical disk.

The power supply component 306 may provide power for all components of the apparatus 300.

The power supply component 306 may include a power supply management system, one or more power supplies, and other units related to generating, managing and distributing power for the apparatus 300.

The multimedia component 308 includes an output interface screen provided between the apparatus 300 and the user. In some embodiments, a screen may include a liquid crystal display (LCD) and a touch panel (TP). When the screen includes a TP, the screen may be implemented as a touch screen to receive an input signal from the user. The touch panel includes one or more touch sensors to sense touching, sliding and gestures on the touch panel. The touch sensor may not only sense the boundary of a touch or slide action, but also detect the duration and pressure related to the touch or slide operation. In some embodiments, the multimedia component 308 includes a front camera and/or a rear camera. When the apparatus 300 is in an operation mode, such as a shooting mode or a video mode, the front camera or the rear camera may receive the external multimedia data. Each front camera and rear camera may be a fixed optical lens system or an optical lens system with a focal length and an optical zoom capacity.

The audio component 310 is configured to output and/or input an audio signal. For example, the audio component 310 includes a microphone (MIC). When the apparatus 300 is in an operation mode, such as a call mode, a record mode, and a speech recognition mode, the microphone is configured to receive the external audio signal. The received audio signal may be further stored in the memory 304 or sent via the communication component 316. In some embodiments, the audio component 310 further includes a speaker configured to output an audio signal.

The I/O interface 312 provides an interface for the processing component 302 and the peripheral interface module, and the peripheral interface module may be a keyboard, a click wheel, a button, etc. The button may include but not limited to a home button, a volume button, a start button and a lock button.

The sensor component 314 includes one or more sensors, configured to provide various aspects of status assessment for the apparatus 300. For example, the sensor component 314 may detect the on/off state of the apparatus 300 and the relative positioning of the component. For example, the component is a display and a keypad of the apparatus 300. The sensor component 314 may further detect the location change of the apparatus 300 or one component of the apparatus 300, the presence or absence of contact between the user and the apparatus 300, the orientation or acceleration/deceleration of the apparatus 300, and the temperature change of the apparatus 300. The sensor component 314 may include a proximity sensor configured to detect the existence of the objects nearby without any physical contact. The sensor component 314 may further include a light sensor such as a complementary metal oxide semiconductor (CMOS) or a charge-coupled device (CCD) image sensor, which is configured to use in imaging applications. In some embodiments, the sensor component 314 may further include an acceleration transducer, a gyroscope sensor, a magnetic sensor, a pressure sensor or a temperature sensor.

The communication component 316 is configured for the convenience of wire or wireless communication between the apparatus 300 and other devices. The apparatus 300 may access wireless networks based on communication standard, such as Wi-Fi, 2G or 3G, or their combination. In an embodiment, the communication component 316 receives broadcast signals or broadcast-related information from an external broadcast management system via a broadcast channel. In an embodiment, the communication component 316 further includes a near field communication (NFC) module to facilitate short-range communication. For example, the NFC module may be achieved based on a radio frequency identification (RFID) technology, an infrared data association (IrDA) technology, an ultra-wide band (UWB) technology, a blue tooth (BT) technology and other technologies.

In an embodiment, the apparatus 300 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronics components, which is configured to perform the above methods.

In an embodiment, a non-transitory computer-readable storage medium is further provided which includes executable instructions, such as the memory 304 including executable instructions, the executable instructions may be executed by the processor 320 of the apparatus 300 to complete the above methods. For example, the non-transitory computer-readable storage medium may be a ROM, a random access memory (RAM), a CD-ROM, a magnetic tape, a floppy disk, an optical data storage device, etc.

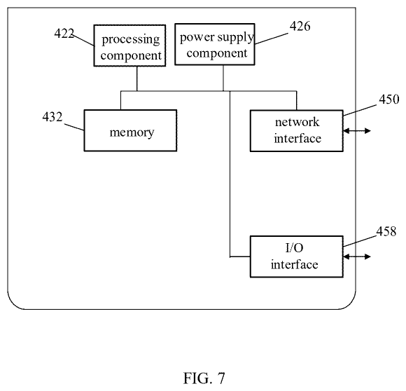

FIG. 7 is a block diagram illustrating a communication apparatus according to an embodiment.

For example, the apparatus 400 may be provided as a network device. Referring to FIG. 7, the apparatus 400 may include a processing component 422, which further includes one or more processors, and a memory resource represented by a memory 432, for storing instructions that may be executed by the processing component 422, such as an application program. The application program stored in the memory 432 may include one or more modules each corresponding to a set of instructions. In addition, the processing component 422 is configured to execute instructions to execute the aforementioned method.

The apparatus 400 may also include a power supply component 426 configured to perform power management of the apparatus 400, a wired or wireless network interface 450 configured to connect the apparatus 400 to a network, and an input output (I/O) interface 458. The apparatus 400 may operate based on an operating system stored in the memory 432, such as a Windows Server™, a Mac OS X™, a Unix™, a Linux™, a FreeBSD™ or the like.

In an embodiment, a non-transitory computer-readable storage medium including instructions is further provided, for example, a memory 432 including instructions, where the instructions may be executed by a processing component 422 of the apparatus 400 to complete the above method.

For example, the non-transitory computer-readable storage medium may be a ROM, a Random Access Memory (RAM), a CD-ROM, a magnetic tape, a floppy disk, or an optical data storage device, and the like.

According to a first aspect of the embodiments of the present disclosure, a communication method is provided, the method being performed by a terminal, the method including: sending first information, where the first information is configured to indicate an AI functionality supported by the terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, where the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, where the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, where the functionality identification of the AI functionality supported by the terminal is determined by the terminal in a custom-defined manner.

In some embodiments, the functionality identification of the AI functionality supported by the terminal is determined by a network device based on the values of the AI functionality supported by the terminal under the different dimensional information.

In some embodiments, the AI functionality supported by the terminal is determined based on third information, where the third information is configured to indicate at least one dimensional information.

In some embodiments, the first information includes a functionality identification of the AI functionality supported by the terminal, where the functionality identification of the AI functionality supported by the terminal is determined by the terminal in a custom-defined manner.

In some embodiments, the first information further includes values of the AI functionality supported by the terminal under another dimensional information.

According to a second aspect of the embodiments of the present disclosure, a communication method is provided, the method being performed by a network device, the method including: receiving first information, where the first information is configured to indicate an AI functionality supported by a terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, where the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, where the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, where the functionality identification of the AI functionality supported by the terminal is determined by the terminal in a custom-defined manner.

In some embodiments, the functionality identification of the AI functionality supported by the terminal is determined by the network device based on the values of the AI functionality supported by the terminal under the different dimensional information.

In some embodiments, the AI functionality supported by the terminal is determined based on third information, where the third information is configured to indicate at least one dimensional information.

In some embodiments, the first information includes a functionality identification of the AI functionality supported by the terminal, where the functionality identification of the AI functionality supported by the terminal is determined by the terminal in a custom-defined manner.

In some embodiments, the first information further includes values of the AI functionality supported by the terminal under another dimensional information.

According to a third aspect of the embodiments of the present disclosure, a communication apparatus is provided, the apparatus including: a sending module, configured to send first information, where the first information is configured to indicate an AI functionality supported by a terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, where the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, where the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, where the functionality identification of the AI functionality supported by the terminal is determined by the terminal in a custom-defined manner.

In some embodiments, the functionality identification of the AI functionality supported by the terminal is determined by a network device based on the values of the AI functionality supported by the terminal under the different dimensional information.

In some embodiments, the AI functionality supported by the terminal is determined based on third information, where the third information is configured to indicate at least one dimensional information.

In some embodiments, the first information includes a functionality identification of the AI functionality supported by the terminal, where the functionality identification of the AI functionality supported by the terminal is determined by the terminal in a custom-defined manner.

In some embodiments, the first information further includes values of the AI functionality supported by the terminal under another dimensional information.

According to a fourth aspect of the embodiments of the present disclosure, a communication apparatus is provided, the apparatus including: a receiving module, configured to receive first information, where the first information is configured to indicate an AI functionality supported by a terminal, and the AI functionality is determined based on different dimensional information.

In some embodiments, the dimensional information includes at least one of the following:
an operating frequency band;
an application scenario;
an input and/or an output of an AI model; or
configuration information.

In some embodiments, each dimensional information includes at least one value, and the AI functionality is determined based on values under the different dimensional information.

In some embodiments, different AI functionalities correspond to different functionality identifications.

In some embodiments, the AI functionality supported by the terminal is determined based on second information, where the second information includes dimensional information respectively corresponding to a plurality of AI functionalities and values respectively corresponding to the plurality of AI functionalities under the different dimensional information.

In some embodiments, the first information includes a functionality identification of the AI functionality supported by the terminal, where the functionality identifications of the plurality of AI functionalities are determined by the terminal based on the dimensional information respectively corresponding to the plurality of AI functionalities and the values respectively corresponding to the plurality of AI functionalities under the different dimensional information.

In some embodiments, the first information includes values of the AI functionality supported by the terminal under the different dimensional information.

In some embodiments, the first information further includes a functionality identification of the AI functionality supported by the terminal, where the functionality identification of the AI functionality supported by the terminal is determined by the terminal in a custom-defined manner.

In some embodiments, the functionality identification of the AI functionality supported by the terminal is determined by a network device based on the values of the AI functionality supported by the terminal under the different dimensional information.

In some embodiments, the AI functionality supported by the terminal is determined based on third information, where the third information is configured to indicate at least one dimensional information.

In some embodiments, the first information includes a functionality identification of the AI functionality supported by the terminal, where the functionality identification of the AI functionality supported by the terminal is determined by the terminal in a custom-defined manner.

In some embodiments, the first information further includes values of the AI functionality supported by the terminal under another dimensional information.

According to a fifth aspect of the embodiments of the present disclosure, a communication apparatus is provided, including: a processor; and a memory for storing processor-executable instructions; where the processor is configured to: execute the communication method according to the above first aspect and the embodiments in the first aspect.

According to a sixth aspect of the embodiments of the present disclosure, a communication apparatus is provided, including: a processor; and a memory for storing processor-executable instructions; where the processor is configured to: execute the communication method according to the above second aspect and the embodiments in the second aspect.

According to a seventh aspect of the embodiments of the present disclosure, a non-transitory storage medium is provided, where instructions are stored in the non-transitory storage medium, and when the instructions stored in the non-transitory storage medium are executed by a processor of a terminal, the terminal is enabled to execute the communication method according to the above first aspect and the embodiments in the first aspect.

According to an eighth aspect of the embodiments of the present disclosure, a non-transitory storage medium is provided, where instructions are stored in the non-transitory storage medium, and when the instructions stored in the non-transitory storage medium are executed by a processor of a network device, the network device is enabled to execute the communication method according to the above second aspect and the embodiments in the second aspect.

The technical solutions provided in the embodiments of the present disclosure may include the following beneficial effects: the terminal sends first information, and through the first information indicates the AI functionality supported by the terminal, such that the network device and the terminal reach an agreement on the AI functionality supported by the terminal.

Further, different AI functionalities are determined based on different dimensional information, which clarifies the determination basis of the AI functionality and improves communication efficiency.

It should be further understood that “a plurality of” in the present disclosure means two or more than two, and other quantifiers are similar. “And/or” describes an associative relationship of associated objects, indicating that three relationships may exist. For example, A and/or B may mean: A exists alone, A and B exist simultaneously, or B exists alone. The character “/” generally indicates that the objects before and after it have an “or” relationship. The singular forms “a”, “the”, and “said” are also intended to include the plural forms, unless the context clearly indicates otherwise.

It should be further understood that the terms “first”, “second”, and the like are used to describe various information, but the information should not be limited to these terms. These terms are only used to distinguish the same type of information from each other, and do not indicate a specific order or importance. In fact, the expressions “first”, “second”, and the like can be used interchangeably. For example, within the scope of the present disclosure, the first information may also be referred to as the second information, and similarly, the second information may also be referred to as the first information.

It should be further understood that although the operations are described in a specific order in the drawings in the embodiments of the present disclosure, they should not be construed as requiring the execution of these operations in the specific order or in a serial order as shown, or as requiring all of the operations to be performed to obtain the desired results. In particular circumstances, multitasking and parallel processing may be advantageous.

Those skilled in the art, upon considering the specification and practicing the invention disclosed herein, will be able to conceive of other embodiments of the present disclosure. This application is intended to cover any modifications, uses, or adaptive changes of the present disclosure, which follow the general principles of the present disclosure and include well-known common knowledge or conventional technical means in the art not disclosed herein.

It should be understood that the present disclosure is not limited to the precise structures already described above and shown in the drawings, and various modifications and changes can be made without departing from the scope thereof. The scope of the present disclosure is only limited by the appended claims.

1. A method for wireless communication, performed by a terminal, the method comprising:
sending first information, wherein the first information is configured to indicate an AI functionality supported by the terminal, and the AI functionality is determined based on different dimensional information.

2. The method according to claim 1, wherein the dimensional information comprises at least one of:
an operating frequency band;
an application scenario;
at least one of an input or an output of an AI model; or configuration information.

3. The method according to claim 1, wherein each dimensional information comprises at least one value, and the AI functionality is determined based on values under the different dimensional information.

4. The method according to claim 3, wherein different AI functionalities correspond to different functionality identifications.

5. The method according to claim 1, wherein the AI functionality supported by the terminal is determined based on second information, and the second information comprises dimensional information respectively corresponding to a plurality of AI functionalities and values respectively corresponding to the plurality of AI functionalities under the different dimensional information.

6. The method according to claim 5, wherein the first information comprises a functionality identification of the AI functionality supported by the terminal, and the functionality identifications of the plurality of AI functionalities are determined by the terminal based on the dimensional information respectively corresponding to the plurality of AI functionalities and the values respectively corresponding to the plurality of AI functionalities under the different dimensional information.

7. The method according to claim 1, wherein the first information comprises values of the AI functionality supported by the terminal under the different dimensional information.

8. The method according to claim 7, wherein the first information further comprises a functionality identification of the AI functionality supported by the terminal, and the functionality identification of the AI functionality supported by the terminal is determined by the terminal in a custom-defined manner.

9. The method according to claim 7, wherein a functionality identification of the AI functionality supported by the terminal is determined by a network device based on the values of the AI functionality supported by the terminal under the different dimensional information.

10. The method according to claim 1, wherein the AI functionality supported by the terminal is determined based on third information, and the third information is configured to indicate at least one dimensional information.

11. The method according to claim 10, wherein the first information comprises a functionality identification of the AI functionality supported by the terminal, and the functionality identification of the AI functionality supported by the terminal is determined by the terminal in a custom-defined manner.

12. The method according to claim 11, wherein the first information further comprises a value of the AI functionality supported by the terminal under another dimensional information.

13. A method for wireless communication, performed by a network device, the method comprising:
receiving first information, wherein the first information is configured to indicate an AI functionality supported by a terminal, and the AI functionality is determined based on different dimensional information.

14. The method according to claim 13, wherein the dimensional information comprises at least one of:
an operating frequency band;
an application scenario;
at least one of an input or an output of an AI model; or configuration information.

15. The method according to claim 13, wherein each dimensional information comprises at least one value, and the AI functionality is determined based on values under the different dimensional information;
wherein different AI functionalities correspond to different functionality identifications.

16. (canceled)

17. The method according to claim 13, wherein the AI functionality supported by the terminal is determined based on second information, and the second information comprises dimensional information respectively corresponding to a plurality of AI functionalities and values respectively corresponding to the plurality of AI functionalities under the different dimensional information;
wherein the first information comprises a functionality identification of the AI functionality supported by the terminal, and the functionality identifications of the plurality of AI functionalities are determined by the terminal based on the dimensional information respectively corresponding to the plurality of AI functionalities and the values respectively corresponding to the plurality of AI functionalities under the different dimensional information.

18. (canceled)

19. The method according to claim 13, wherein the first information comprises values of the AI functionality supported by the terminal under the different dimensional information;
wherein the first information further comprises a functionality identification of the AI functionality supported by the terminal, and the functionality identification of the AI functionality supported by the terminal is determined by the terminal in a custom-defined manner; or
wherein the functionality identification of the AI functionality supported by the terminal is determined by the network device based on the values of the AI functionality supported by the terminal under the different dimensional information.

20.-21. (canceled)

22. The method according to claim 13, wherein the AI functionality supported by the terminal is determined based on third information, and the third information is configured to indicate at least one dimensional information;
wherein the first information comprises a functionality identification of the AI functionality supported by the terminal, and the functionality identification of the AI functionality supported by the terminal is determined by the terminal in a custom-defined manner; and
wherein the first information further comprises a value of the AI functionality supported by the terminal under another dimensional information.

23.-24. (canceled)

25. A communication apparatus, comprising:
a processor;
a memory for storing processor-executable instructions;
wherein the processor is configured to:
send first information, wherein the first information is configured to indicate an AI functionality supported by a terminal, and the AI functionality is determined based on different dimensional information.

26.-27. (canceled)

28. A communication apparatus, comprising:
a processor;
a memory for storing processor-executable instructions;
wherein the processor-executable instructions when executed by the processor cause the communication apparatus to act as the network device and perform the method according to claim 13.

29.-30. (canceled)
